(19) United States
(12) Patent Application Publication
(10) Pub. No.: US 2009/0152933 A1
(43) Pub. Date: Jun. 18, 2009

(54) SEAT BELT TENSION SENSOR ASSEMBLY

(75) Inventor: Gary L. Casey, Thousand Oaks, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: CUSTOM SENSORS & TECHNOLOGIES, INC., Moorpark, CA (US)

(21) Appl. No.: 11/957,319

(22) Filed: Dec. 14, 2007

(51) Int. Cl. B60R 22/195

(52) U.S. Cl. 297/480

(57) ABSTRACT

Described herein is a seat belt tension sensor assembly that includes an anchor plate adapted to be secured to an object, a housing associated with and movable with respect to the anchor plate, wherein the housing defines a cavity therein, and a sense element disposed in the cavity. The sense element is adapted to produce an output in response to a force placed thereon. The output provided by the sense element is a function of the force placed on the housing by a seat belt up to a predetermined maximum value. The housing does not move until the maximum value is reached, and, after the maximum value is reached, the output of the sense element does not substantially change from the maximum value.

### FIELD OF THE INVENTION

The present invention relates to a seat belt tension sensor, and more particularly to a simple and accurate seat belt tension sensor assembly that includes overload protection.

### BACKGROUND OF THE INVENTION

Seat belt tension sensors are often complex, costly and less accurate than desirable. Accordingly, a need exists for a seat belt tension sensor that overcomes these issues.

### SUMMARY OF THE INVENTION

In accordance with a first aspect of the present invention there is provided a seat belt tension sensor assembly for use with a seat belt that includes an anchor plate that is adapted to be secured to an object. The anchor plate includes a sensor opening defined therethrough. The assembly further includes a housing that has first and second housing halves that define a cavity therebetween. A portion of each of the housings halves are received in the sensor opening of the anchor plate and the housing is movable with respect to the anchor plate. The housing and the anchor plate cooperate to define a seatbelt opening. The assembly also includes a sense element disposed in the cavity that is adapted to produce an electrical signal in response to a force placed thereon, and a preloaded spring disposed in the cavity between the sense element and the anchor plate. The preloaded spring is adapted to compress when the force placed on the housing by the seat belt is greater than the spring force. In one embodiment, the spring is preloaded by a clip that holds the spring in a partially compressed position, thereby forming a spring assembly. The spring assembly is disposed between the sense element and the anchor plate. In an embodiment, the housing is movable between a first position and a second position, and in the second position, the force exerted on the sense element by the spring is no greater than the spring force.

In accordance with another aspect of the present invention there is provided a seat belt tension sensor assembly that includes an anchor plate adapted to be secured to an object, a housing associated with and movable with respect to the anchor plate, wherein the housing defines a cavity therein, and a sense element disposed in the cavity. The sense element is adapted to produce an output in response to a force placed thereon. The output provided by the sense element is a function of the force placed on the housing by a seat belt up to a predetermined maximum value. The housing does not move until the maximum value is reached, and, after the maximum value is reached, the output of the sense element does not substantially change from the maximum value.

In accordance with yet another aspect of the present invention there is provided a method that includes providing a seat belt tension sensor assembly that comprises an anchor plate secured to an object, a housing that defines a cavity therein and is associated with and movable with respect to the anchor plate, and a sense element disposed in the cavity. The sense element is adapted to produce an output in response to a force placed thereon. The output provided by the sense element is a function of the force placed on the housing by a seat belt up to a predetermined maximum value. The method further includes placing a first force on the housing that is less than the maximum value, thereby providing a first output. The first output is directly proportional to the first force and the housing does not move as a result of the first force. The method further includes placing a second force on the housing that is greater than the maximum value, thereby providing a second output. The second output is not directly proportional to the second force and the placement of the second force on the housing causes the housing to move. In an embodiment, the method further includes placing a third force on the housing that is greater than the maximum value, thereby providing a third output that is substantially the same as the second output. The placement of the third force on the housing causes the housing to move.

### BRIEF DESCRIPTION OF THE DRAWINGS

FIG. 1 is a perspective view of a seat belt tension sensor assembly in accordance with a preferred embodiment of the present invention;

FIG. 2 is an exploded perspective view of the seat belt tension sensor assembly of FIG. 1;

FIG. 3 is a perspective view of the seat belt tension sensor assembly of FIG. 1 with the cover removed;

FIG. 4 is a cross-sectional side elevational view of the seat belt tension sensor assembly of FIG. 1;

FIG. 5 is a perspective view of the sense element of the seat belt tension sensor assembly of FIG. 1;

FIG. 6 is a perspective view of the seat belt tension sensor assembly of FIG. 1 with the cover exploded therefrom to show the wiring connection therein;

FIG. 7 is a front elevational view of the seat belt tension sensor assembly of FIG. 1 with the cover removed to show the assembly in both a non-actuated and an actuated state; and

FIG. 8 is a front elevational view of the seat belt tension sensor assembly of FIG. 1 with the cover removed to show the assembly in a protective state.

Like numerals refer to like parts throughout the several views of the drawings.

### DESCRIPTION OF THE INVENTION

As shown in the drawings, for purposes of illustration, the invention is embodied in a seat belt tension sensor assembly 10. In a preferred embodiment, the seat belt tension sensor assembly 10 is used in an automobile, however, this is not a limitation on the present invention.

It will be appreciated that terms such as “front,” “back,” “top,” “bottom,” “left,” “right,” “above,” and “side” used herein are merely for ease of description and refer to the orientation of the components as shown in the figures. It should be understood that any orientation of the seat belt tension sensor assembly, and the components thereof described herein, is within the scope of the present invention.

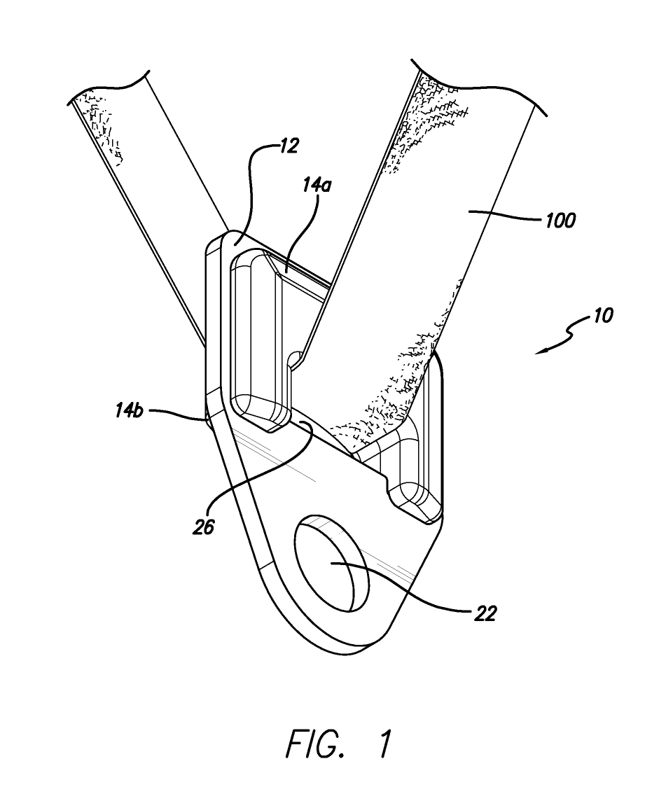

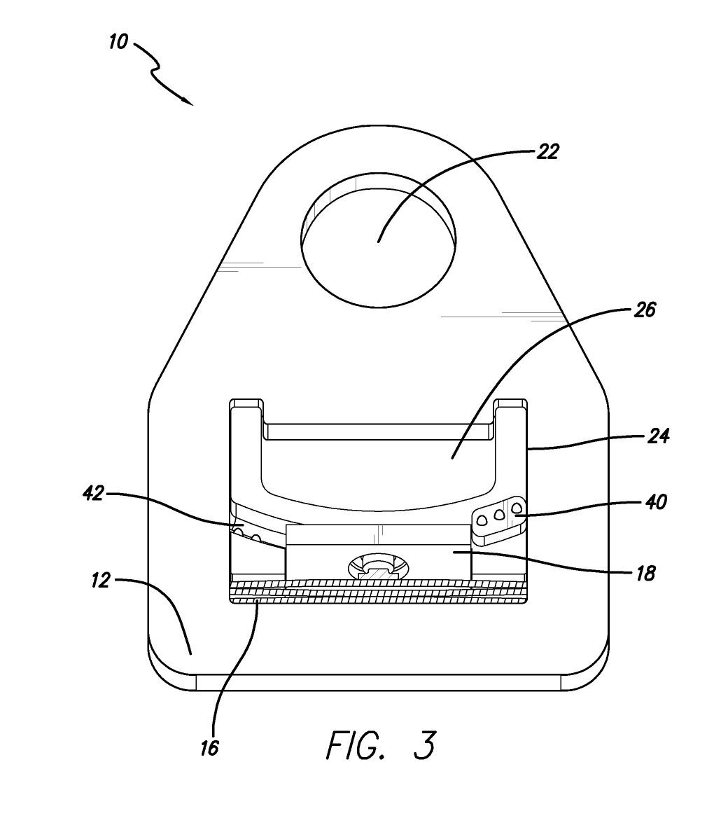

As shown in FIGS. 1-4, generally, the seat belt tension sensor assembly 10 includes a base plate 12, housing 14 (comprising housing halves 14a and 14b, sometimes referred to herein simply as housings 14a and 14b), spring assembly 16 and sense element 18.

In a preferred embodiment, the base plate 12 has front and back faces 12a and 12b and is attached to the vehicle structure through an attachment opening 22 defined therethrough, as is known in the art. The base plate 12 also has a sensor opening 24 defined therethrough that receives a portion of housings 14a and 14b and through which a seat belt 100 extends. It will be understood by those skilled in the art that the base plate 12 is an anchor point that connects the seat belt to the vehicle structure, such as the floor (by a bolt, screw, rivet or the like). Accordingly, the base plate 12 is advantageously made of a rigid metal, such as steel or the like.

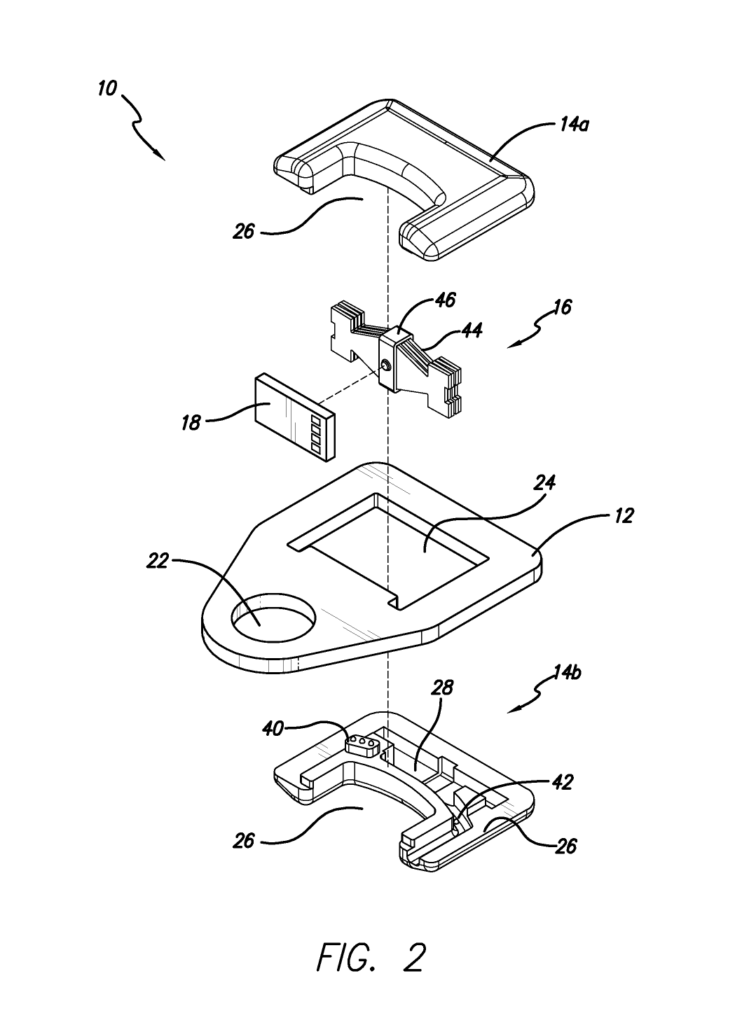

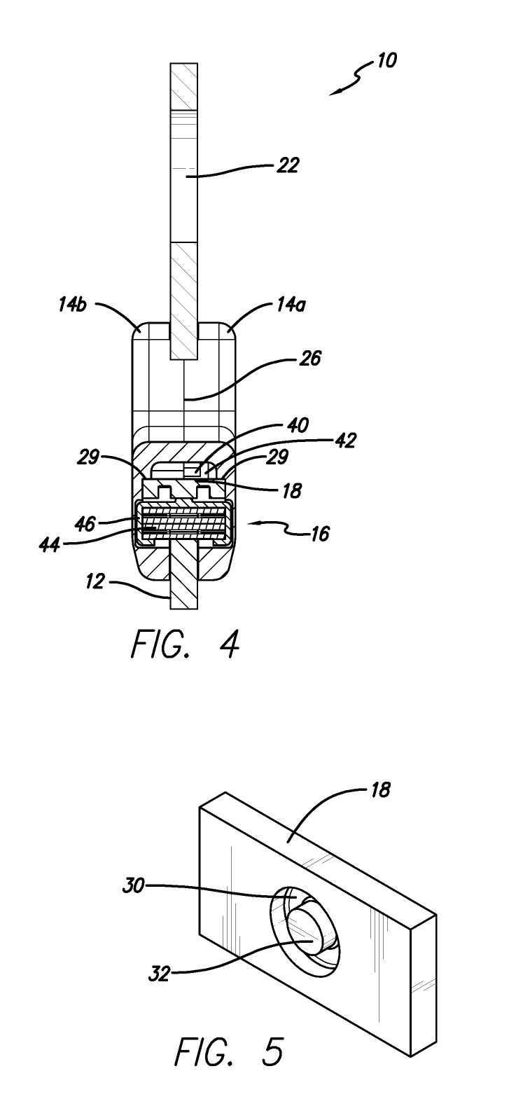

As is best shown in FIGS. 2-4, housings 14a and 14b each include a surface 26 that is adjacent to the front or back face 12a, 12b of the base plate 12 (they are not connected to the base plate 12 because they need to be able to move relative to it) and a portion that is disposed in sensor opening 24. The housings halves 14a and 14b are held together by a press fit arrangement of the protrusion/plug 40 on one housing 14a or 14b being received in the associated groove/slot 42 in the other housing (described more fully below and shown in FIG. 4). In another embodiment, the housing halves 14a and 14b can be held together by screws, rivets or the like. Housings 14a and 14b are shaped to cooperate with plate 12 to define a belt opening 26, through which the seat belt 100 extends. Housing halves 14a and 14b also each include a recess 28 (collectively referred to as a cavity) defined therein for receiving sense element 18 and spring assembly 16.

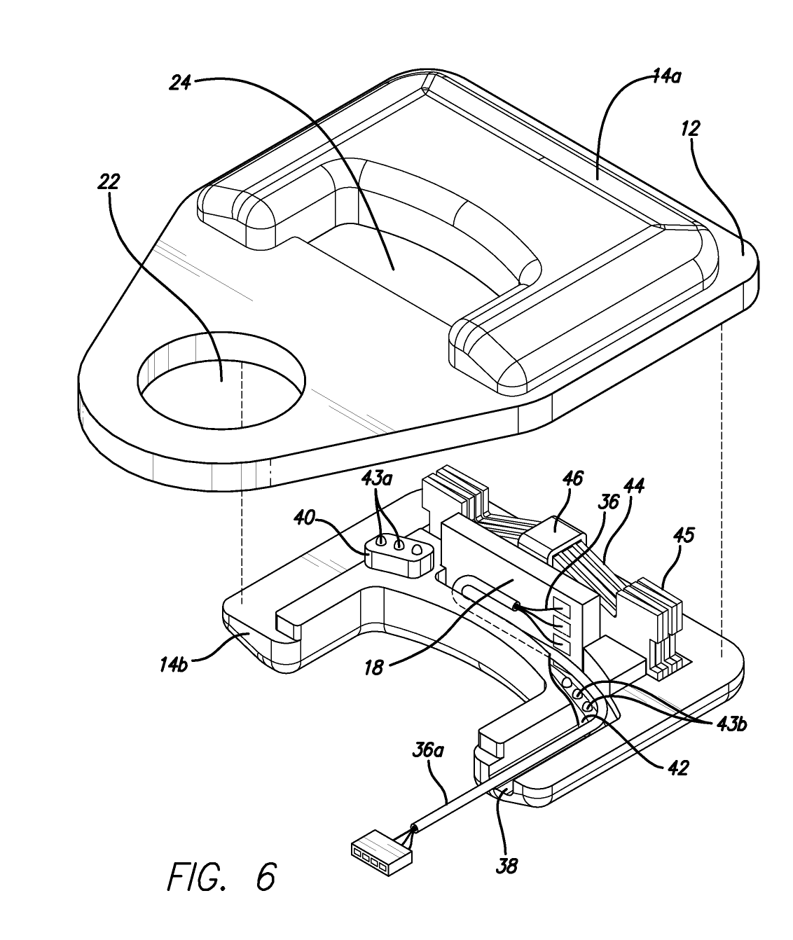

As shown in FIGS. 4 and 6, in a preferred embodiment, each of the housings 14a and 14b include a ledge 29 that prevents movement of the sense element 18 in the direction toward the seat belt loop and away from the spring assembly 16.

As is best shown in FIG. 5, in a preferred embodiment, the sense element 18 contains a diaphragm 30 and a center pedestal 32. In one embodiment, the sense element can be made of steel. A portion of the structure is thinned (30) to form a diaphragm so that when force is applied to the center pedestal 32 a significant stress and accompanying strain is created at the outer portion of the diaphragm 30 and opposite strain at the inner portion at the interface with the center pedestal 32. On the back side (not shown) a continuous layer of glass is deposited, followed by patterned layers of conductor and resistor material. The resistor material is strain sensitive and if appropriately patterned (as known by those skilled in the art) creates a Wheatstone bridge with a differential voltage output that changes in proportion to the strain on the surface of the diaphragm 30. This output is sensed by an electronic circuit, which, in an advantageous embodiment is implemented in an Application-Specific Integrated Circuit (ASIC) that is also soldered to the surface of the sense element. This circuit can then be compensated through a calibration process so that the output voltage is a precise function of the applied force. Typically, the ASIC is connected to the vehicle controller by three wires 36—power in, ground and signal out. The strain-sensitive elements and their associated circuitry are collectively indicated by reference numeral 34 in FIG. 6. In a preferred embodiment, the electrical signals produced by the sense element are electrically communicated to a desired electrical component, such as a control unit for the air bags, by wires 36. For exemplary purposes only, FIG. 6 shows a connector 102 that might be used to make the connection.

Wires 36 (that may be contained in a wire harness 36a) are housed in a slot 38 in one of the housings 14a or 14b. In the figures, the slot 38 is defined in housing 14b. In a preferred embodiment, for strain relief during actuation, each housing 14a and 14b includes a plug 40 that is received in a groove 42 in the opposite housing. As is shown in FIG. 6, in housing 14b, groove 42 and slot 38 cooperate to provide a path for wires 36. In a preferred embodiment, the plug 40 has a plurality of bumps 43a that will push the cable between them and a plurality of similar bumps 43b in the groove 42 in the opposite housing. When pressed together the bumps 43a and 43b provide an “S-curve” labyrinth that locks the wire harness 36a in place. In a preferred embodiment the wires 36 are soldered to the solder pads and initially extend in a direction opposite the exit path (groove 42 and slot 38). The wires 36 then make an approximate 180 degree turn, thus creating a strain-relieving loop. It will be understood that this configuration is not a limitation on the present invention, but that the wires can exit the housing 14 at any point.

As is shown in FIGS. 2-4 and 6, spring assembly 16 is received in a portion of recess 28. In a preferred embodiment, the spring assembly 16 includes a leaf spring 44 that is retained by a clip 46. It will be understood that the spring 44 is preloaded in this position and has a spring force (the force necessary to begin compressing the spring) that is equal to or higher than the maximum force desired to be measured. It will be understood that the clip 46 captures the spring 44 in the desired preloaded configuration. Therefore, any way of capturing the spring (no matter what type of spring it is) and limiting its movement is within the scope of the present invention. In a preferred embodiment, the clip 46 includes a knob 48 thereon that is in mechanical communication with the pedestal 32 of the sense element 18.

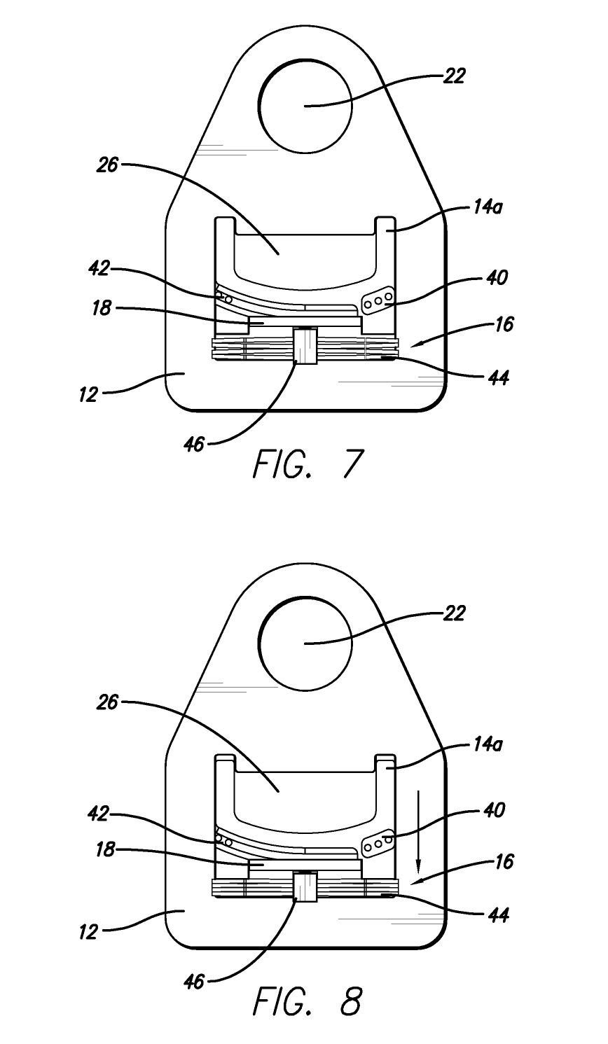

Referring to FIGS. 7-8, the seat belt tension sensor assembly 10 basically has three states, a non-actuated state, where no tension is applied to the housing 14 by the seat belt 100. An actuated state, where tension is applied to the housing 14 by the seat belt 100, but the maximum force desired to be measured has not been exceeded. And, a protective state, where the tension applied to the housing 14 by the seat belt 100 exceeds the maximum force desired to be measured and the spring assembly 16 begins to compress. It will be understood that FIG. 7 shows both the non-actuated and actuated state and FIG. 8 shows the protective state.

In the non-actuated state, the spring assembly 16 spring rests “loose” within the assembly clearances designed. At this point, there is little or no force being exerted on the sense element, as is shown in FIG. 7.

In operation, when a tension creating incident creates tension in the seat belt 100 and places force on the housing 14, the sense element 18 is forced against the spring assembly 16 and the resulting contact creates a proportional electric signal that is processed by the electronic circuitry 34 and transmitted to the appropriate external electric circuitry via wires 36. This is the actuated state.

In other words, when there is no tension on the belt 100 the sense element 18 has no force exerted on it because the spring 44 is captive, or trapped. With normal belt tension the spring assembly 16 remains in this state and is essentially a rigid block, transferring force without any displacement, as is shown in FIG. 7.

The actuated state is for the purpose of measuring the seat belt tension during normal usage, not during an accident. Two exemplary tension creating incidents are as follows: The first is that the weight of the occupant as measured by an associated seat weight sensor includes the force of the seat belt, so, to get an accurate measure of the occupant weight, the seat belt tension (as is measured in the actuated state) needs to be subtracted. The second is that when using a child safety seat the seat belt should be tensioned to a high level. And this level is constant whether the vehicle is occupied or not. This constant high force can indicate the presence of an infant in the seat, disabling the air bag.

It should be understood that during the actuated state the housing 14 does not move relative to the plate 12 and therefore the effect of friction that might accompany such movement is eliminated. This enables the sense element 18 to provide an accurate signal in the actuated state.

However, as shown in FIG. 8, when the force increases to a value higher than the maximum force desired to be measured (above full scale) the spring assembly 16 begins to compress or collapse, allowing the housing halves 14a and 14b to move. When the housing halves 14a and 14b move enough to “bottom out” (as shown in FIG. 8) by contacting the plate 12 through the wings 45 (discussed below) of the spring 44, which act as pads or stops, the housing 14 ceases movement. In an exemplary embodiment, each of the housing halves 14a and 14b include shoulders 47, and the shoulders are the portion of the housing that contact the plate 12. After this, regardless of how much tension or force is applied, the sense element 18 is exposed only to the force of the spring assembly 16, thereby protecting the sense element 18 and preventing it from being damaged. This is the protective state.

In a preferred embodiment, the leaf spring 44 includes wings 45 at the ends. As shown in FIG. 2, the wings 45 are wider than the majority of the remainder of the leaf spring. The wings 45 help distribute the load from the plate 12 to the housing 14 when the load is high. This allows the housing 14 to be made of a lower strength and lower cost material than would otherwise be required if the wings 45 were not present. However, it will be understood that the wings 45 can be omitted. The wings can also include notches that cooperate with the plate 12, and help maintain the spring assembly 16 in place.

It should be understood, that while a stacked leaf spring 44 is shown other types of springs can be used as long as the spring is “captured,” in other words, preloaded. The fundamental concept is that the sense element pushes on the preloaded spring, which acts like a rigid body. In another embodiment, a projection that extends from or is integral with the plate 12 can contain the spring, and the sense element may be in direct contact with the spring.

When the force exceeds the rated load, the spring 44 starts to compress, limiting the load imparted on the sense element 18. Then the parts bottom out and the load is transferred directly from the belt 100 to the plate 12. This force could be, for example, up to about 1,500 pounds. In this example, the assembly 10 could accurately measure a load up to about 30 pounds, but is not damaged if the load goes to about 1500 pounds.

An exemplary use of the sensor assembly 100 will now be described. Normal belt tension while being worn is typically less than 30 pounds, and is usually much less. If a baby seat is installed the tension will likely be higher than 30 pounds but will be substantially constant. In the case of a baby seat, the sensor will read a fixed force. The control unit will interpret this fixed high force as an indication that a baby seat is in place and will not allow the air bag to deploy. Regardless, if the vehicle is in a crash the belt tension will be much higher than 30 pounds (possibly up to 1,500 pounds or more). In a situation where this much force is realized, it is desirable to not cause damage to the tension sensor, which will save repair costs.

In a preferred embodiment, in a situation where the seat belt 100 is pulled out of plane, because the housings 14a and 14b are made of a plastic or the like, the housing 14 absorbs the force, also helping prevent and minimize damage to the assembly 10 and sense element 18, in particular.

Finally, in the case of extreme crash forces that are strong enough to break the housing 14 the seat belt 100 is still retained by the plate 12, which is a single, strong structure.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. A seat belt tension sensor assembly for use with a seat belt comprising:
a. an anchor plate that is adapted to be secured to an object, wherein the anchor plate includes a sensor opening defined therethrough,
b. a housing that includes first and second housing halves that define a cavity therebetween, wherein a portion of each of the housings halves are received in the sensor opening of the anchor plate, wherein the housing is movable with respect to the anchor plate, and wherein the housing and the anchor plate cooperate to define a seat belt opening,
c. a sense element disposed in the cavity, wherein the sense element is adapted to produce an electrical signal in response to a force placed thereon, and
d. a preloaded spring disposed in the cavity between the sense element and the anchor plate, wherein the preloaded spring has a spring force, wherein the spring is adapted to compress when the force placed on the housing by the seat belt is greater than the spring force.

2. The seat belt tension sensor assembly of claim 1 wherein the spring is preloaded by a clip that holds the spring in a partially compressed position, thereby forming a spring assembly, and wherein the spring assembly is disposed between the sense element and the anchor plate.

3. The seat belt tension sensor assembly of claim 1 wherein the housing is movable between a first position and a second position, and wherein in the second position, the force exerted on the sense element by the spring is no greater than the spring force.

4. The seat belt tension sensor assembly of claim 3 wherein the housing includes shoulders, and wherein the shoulders come into contact with the spring when the housing is in the second position.

5. The seat belt tension sensor assembly of claim 4 wherein the spring is a leaf spring that includes wings, and wherein the shoulders come into contact with the wings when the housing is in the second position

6. The seat belt tension sensor assembly of claim 1 wherein the sense element includes a diaphragm and a center pedestal, wherein the center pedestal is in mechanical communication with the preloaded spring.

7. The seat belt tension sensor assembly of claim 1 wherein each of the housing halves includes a plug extending inwardly therefrom that is press fit into a corresponding groove in the other housing half.

8. The seat belt tension sensor assembly of claim 1 comprising
a non-actuated state where approximately no force is placed on the sense element,
an actuated state where the force placed on the housing by the seat belt and the force placed on the sense element is greater than zero and less than the spring force, wherein the housing does not move in the actuated state, and
a protective state where the force exerted on the housing by the seat belt is greater than the spring force and the force exerted on the sense element is no greater than the spring force.

9. A seat belt tension sensor assembly comprising:
an anchor plate adapted to be secured to an object,
a housing associated with and movable with respect to the anchor plate, wherein the housing defines a cavity therein, and
a sense element disposed in the cavity, wherein the sense element is adapted to produce an output in response to a force placed thereon,
wherein the output provided by the sense element is a function of the force placed on the housing by a seat belt up to a predetermined maximum value, wherein the housing does not move until the maximum value is reached, and wherein after the maximum value is reached, the output of the sense element does not substantially change from the maximum value.

10. The seat belt tension sensor assembly of claim 9 further comprising a spring disposed between the sense element and the housing, wherein the spring begins to compress when the maximum value is reached.

11. The seat belt tension sensor assembly of claim 10 wherein the spring is preloaded.

12. The seat belt tension sensor assembly of claim 11 wherein the sense element includes a diaphragm and a center pedestal, wherein the center pedestal is in mechanical communication with the preloaded spring.

12. The seat belt tension sensor assembly of claim 10 wherein the housing moves between a first position and a second position after the maximum value is reached, and the output does not substantially change while the housing moves between the first position and the second position.

13. A method comprising the steps of:
a) providing a seat belt tension sensor assembly that comprises
an anchor plate secured to an object,
a housing associated with and movable with respect to the anchor plate, wherein the housing defines a cavity therein, and
a sense element disposed in the cavity, wherein the sense element is adapted to produce an output in response to a force placed thereon,
wherein the output provided by the sense element is a function of the force placed on the housing by a seat belt up to a predetermined maximum value,
b) placing a first force on the housing that is less than the maximum value, thereby providing a first output, wherein the first output is directly proportional to the first force and the housing does not move as a result of the first force, and
c) placing a second force on the housing that is greater than the maximum value, thereby providing a second output, wherein the second output is not directly proportional to the second force and wherein the placement of the second force on the housing causes the housing to move.

14. The method of claim 13 further comprising the step of placing a third force on the housing that is greater than the maximum value, thereby providing a third output, wherein the third output is substantially the same as the second output and wherein the placement of the third force on the housing causes the housing to move.

15. The method of claim 13 wherein the seat belt tension sensor assembly further comprises a spring disposed between the sense element and the housing, wherein the spring begins to compress when the maximum value is reached.

16. The method of claim 15 wherein the spring is preloaded.

17. The method of claim 16 wherein the spring is a leaf spring at least partially surrounded by a clip, wherein the clip holds the spring in partial compression.
